(19) United States
(12) Patent Application Publication
(10) Pub. No.: US 2023/0347889 A1
(43) Pub. Date: Nov. 2, 2023

(54) Autonomous Driving Control Apparatus and Method for Controlling Setting Speed Thereof

(71) Applicants: Hyundai Motor Company, Seoul (KR); Kia Corporation, Seoul (KR)

(72) Inventors: Cheol Hwan Yun, Seoul (KR); Han Na Yun, Seoul (KR)

(21) Appl. No.: 17/970,936

(22) Filed: Oct. 21, 2022

(30) Foreign Application Priority Data
Apr. 29, 2022 (KR) 10-2022-0053591

(51) Int. Cl. B60W 30/14; B60W 40/105; B60W 50/08; B60W 60/00

(52) U.S. Cl. CPC B60W 30/143; B60W 40/105; B60W 50/08; B60W 60/001; B60W 2050/0066

(57) ABSTRACT

An embodiment autonomous driving control apparatus includes a set speed control panel configured to be manipulated to adjust a set speed that is followed by a vehicle during autonomous driving and a processor configured to control an increase or a decrease in the set speed to set an adjusted set speed based on a manipulation duration of the set speed control panel and to control the vehicle to follow the adjusted set speed.

### CROSS-REFERENCE TO RELATED APPLICATIONS

This application claims the benefit of Korean Patent Application No. 10-2022-0053591, filed on Apr. 29, 2022, which application is hereby incorporated herein by reference.

### TECHNICAL FIELD

The present disclosure relates to an autonomous driving control apparatus and a set speed control method therefor.

### BACKGROUND

Recently, a number of people interested in autonomous vehicles is increasing. A currently commercialized autonomous vehicle is equipped with a smart cruise control (SCC) system that sets a set speed of the vehicle and controls the vehicle to drive autonomously by following the set speed, or a cruise control (CC) system.

Conventionally, when changing a set speed limit of the SCC or the CC to a road speed limit, a method of manipulating a tumbler switch, pressing a dedicated button, touching a speed limit displayed on a display device, or manipulating a specific switch by notifying that the speed limit is changed, etc. are applied.

However, when a difference between the current set speed and the road speed limit is large, a conventional tumbler switch for adjusting the set speed can be manipulated to change the set speed to the road speed limit but it is necessary to continuously repeat the manipulation or maintain a manipulation state for a long time after the manipulation, so it is difficult to perform the manipulation as quickly as a driver wants.

In addition, a conventional dedicated button method or display device touch method for adjusting the set speed limit to the road speed limit increases the cost and complexity, and is a method of providing a quick change only at the time of recognizing or changing the speed limit, which lacks continuity.

The above information disclosed in this background section is only for enhancement of understanding of the background of the disclosure, and therefore, it may contain information that does not form the prior art that is already known to a person of ordinary skill in the art.

### SUMMARY

The present disclosure relates to an autonomous driving control apparatus and a set speed control method therefor. Particular embodiments relate to a technique for setting a set speed depending on manipulation duration of a set speed control panel of an autonomous vehicle.

An exemplary embodiment of the present disclosure provides an autonomous driving control apparatus and a set speed control method therefor, capable of increasing user satisfaction by making it possible to quickly set or change a set speed for autonomous driving control to a road speed limit depending on manipulation duration of a set speed control panel during autonomous driving.

The technical features of embodiments of the present disclosure are not limited to the features mentioned above, and other technical features not mentioned may be clearly understood by those skilled in the art from the description of the claims.

An exemplary embodiment of the present disclosure provides an autonomous driving control apparatus including a set speed control panel configured to be manipulated by a user to adjust a set speed that is followed by a vehicle during autonomous driving and a processor configured to control an increase or decrease in the set speed depending on manipulation duration of the set speed control panel and to control the vehicle to follow the set speed.

In an exemplary embodiment of the present disclosure, the processor may determine increasing manipulation or decreasing manipulation depending on the manipulation direction of the set speed control panel.

In an exemplary embodiment of the present disclosure, the processor, when the increasing manipulation of the set speed control panel is performed, may determine whether the manipulation duration of the set speed control panel is equal to or greater than a predetermined first reference value.

In an exemplary embodiment of the present disclosure, the processor may increase the set speed by a first predetermined unit when the manipulation duration of the set speed control panel is smaller than the first reference value.

In an exemplary embodiment of the present disclosure, the processor may determine whether the manipulation duration of the set speed control panel is equal to or greater than a second reference value that is greater than the first reference value when the manipulation duration of the set speed control panel is greater than or equal to the predetermined first reference value.

In an exemplary embodiment of the present disclosure, the processor, when the manipulation duration of the set speed control panel is smaller than the second reference value, may increase the set speed by a second unit that is greater than the first unit.

In an exemplary embodiment of the present disclosure, the processor may determine whether a current set speed of the vehicle is lower than a speed limit of a driving road when the manipulation duration of the set speed control panel is equal to or greater than the second reference value, and may change the current set speed of the vehicle to the speed limit of the driving road when the current set speed is lower than the speed limit of the driving road.

In an exemplary embodiment of the present disclosure, the processor, when the decreasing manipulation of the set speed control panel is performed, may determine whether the manipulation duration of the set speed control panel is equal to or greater than a predetermined first reference value.

In an exemplary embodiment of the present disclosure, the processor may decrease the set speed by a first predetermined unit when the manipulation duration of the set speed control panel is smaller than the predetermined first reference value.

In an exemplary embodiment of the present disclosure, the processor may determine whether the manipulation duration of the set speed control panel is equal to or greater than a second reference value that is greater than the first reference value when the manipulation duration of the set speed control panel is greater than or equal to the predetermined first reference value.

In an exemplary embodiment of the present disclosure, the processor may decrease the set speed by a second unit that is greater than the first unit when the manipulation duration of the set speed control panel is smaller than the predetermined second reference value.

In an exemplary embodiment of the present disclosure, the processor may determine whether a current set speed of the vehicle exceeds a speed limit of a driving road when the manipulation duration of the set speed control panel is equal to or greater than the second reference value, and may change the current set speed to the speed limit of the driving road when the current set speed exceeds the speed limit of the driving road.

In an exemplary embodiment of the present disclosure, the set speed control panel may include at least one of a ball-type scroll switch, a roll-type scroll switch, a lever switch, a left-right rotation scroll switch, or a touch screen or any combination thereof.

In an exemplary embodiment of the present disclosure, the processor may determine a time for pressing and maintaining a button having a one-step pressing function as the manipulation duration when the set speed control panel includes the button.

In an exemplary embodiment of the present disclosure, the processor, when the set speed control has a button including a two-step pressing function, may determine a time for pressing and maintaining the button as the manipulation duration depending on pressing strength of the button.

In an exemplary embodiment of the present disclosure, the processor may determine a time for swiping and maintaining a touch button up or down as the manipulation duration when the set speed control panel includes the touch button, and may determine a time for swiping and maintaining a touch button up or down as the manipulation duration when the set speed control panel includes the touch button.

In an exemplary embodiment of the present disclosure, the processor, when the set speed control panel includes a touch button and an area of the touch button includes an increasing manipulation area for increasing the set speed and a decreasing manipulation area for decreasing the set speed, may determine a time for touching and maintaining each of the increasing manipulation area or the decreasing manipulation area as the manipulation duration.

In an exemplary embodiment of the present disclosure, the processor may determine a time for raising or lowering and maintaining a tumbler switch and a lever switch as the manipulation duration when the set speed control panel is the tumbler switch or the lever switch.

In an exemplary embodiment of the present disclosure, the processor may determine a time for rotating and maintaining a rotation portion of a lever switch up or down as the manipulation duration when the set speed control panel is the lever switch.

An exemplary embodiment of the present disclosure provides a setting speed control method including receiving manipulation of a set speed control panel from a user to adjust a set speed for the vehicle to follow during autonomous driving, controlling an increase or decrease in the set speed depending on manipulation duration of the set speed control panel, and controlling the vehicle to follow the set speed.

According to embodiments of the present technique, it is possible to increase user satisfaction by making it possible to quickly set or change a set speed for autonomous driving control to a road speed limit depending on manipulation duration of a set speed control panel during autonomous driving.

Furthermore, various effects that can be directly or indirectly identified through this document may be provided.

### BRIEF DESCRIPTION OF THE DRAWINGS

FIG. 1 illustrates a block diagram showing a configuration of an autonomous vehicle including an autonomous driving control apparatus according to an exemplary embodiment of the present disclosure.

FIG. 2 illustrates an example of a set speed switch according to an exemplary embodiment of the present disclosure.

FIG. 3 and FIG. 4 each illustrate a flowchart showing a set speed control method during autonomous driving control according to exemplary embodiments of the present disclosure.

FIG. 5 illustrates a computing system according to an exemplary embodiment of the present disclosure.

### DETAILED DESCRIPTION OF ILLUSTRATIVE EMBODIMENTS

Hereinafter, some exemplary embodiments of the present disclosure will be described in detail with reference to exemplary drawings. It should be noted that in adding reference numerals to constituent elements of each drawing, the same constituent elements have the same reference numerals to the extent possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to exemplary embodiments of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

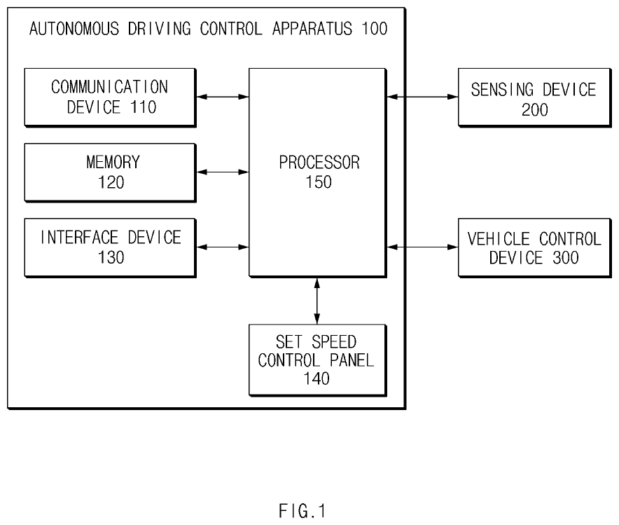

Hereinafter, various exemplary embodiments of the present disclosure will be described in detail with reference to FIG. 1 to FIG. 5.

FIG. 1 illustrates a block diagram showing a configuration of an autonomous vehicle including an autonomous driving control apparatus according to an exemplary embodiment of the present disclosure.

The autonomous driving control apparatus 100 according to an exemplary embodiment of the present disclosure may be implemented inside the vehicle. In the instant case, the autonomous driving control apparatus 100 may be integrally formed with internal control units of the vehicle, or may be implemented as a separate device to be connected to control units of the vehicle by a separate connection means. In addition, the autonomous driving control apparatus 100 may be applied to a smart cruise control (SCC) system or a cruise control (CC) system, etc., and may be applied to all autonomous vehicles using a set speed by setting or changing it.

The autonomous driving control apparatus 100 may control an increase or decrease in a set speed depending on manipulation duration of a set speed control panel 140 manipulated by a user and may control the vehicle to follow the set speed.

In this case, the set speed is a speed that is set for an autonomous vehicle to follow for autonomous driving, and the autonomous driving control apparatus 100 controls the vehicle to drive while following the set speed. For example, when the set speed is set to “100” on the highway, the autonomous driving control apparatus 100 may control the vehicle to travel at the set speed of 100.

Referring to FIG. 1, the autonomous driving control apparatus 100 may include a communication device 110, a memory (i.e., a storage) 120, an interface device 130, a set speed control panel 140, and a processor 150.

The communication device no is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, Ethernet communication, and the like.

Furthermore, the communication device no may perform communication by using a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, world interoperability for microwave access (Wimax), Ethernet communication, etc. Furthermore, the short-range communication technique may include Bluetooth, ZigBee, ultra wideband (UWB), radio frequency identification (RFID), infrared data association (IrDA), and the like. For example, the communication device no may receive a sensing result from a sensing device 200 to transmit it to the processor 150.

The memory 120 may store sensing results of the sensing device 200 and data and/or algorithms required for the processor 150 to operate, and the like. As an example, the memory 120 may store driving road map information, vehicle surrounding information (image data captured through a camera), a vehicle path (driving path from a start point to a destination), and the like.

The memory 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the autonomous driving control apparatus 100 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated. In the instant case, the display may include at least one of a liquid crystal display (LCD), a thin film transistor liquid crystal display (TFT LCD), an organic light emitting diode display (OLED display), a flexible display, a field emission display (FED), or a 3D display or any combination thereof. As an example, the interface device 130 may be implemented as a head-up display (HUD), a cluster, an audio video navigation (AVN), a human machine interface (HMI), a user setting menu (USM), a monitor, an AR-enabled windshield display, or the like.

For example, the interface device 130 may display an autonomous driving state, a current vehicle speed, a current set speed, a changed set speed, and the like.

The set speed control panel 140 may include at least one button for performing at least one function, or may include a touch button, a tumbler switch, and a lever switch. In addition, the set speed control panel 140 may include at least one of a ball-type scroll switch, a roll-type scroll switch, a lever switch, a left-right rotation scroll switch, or a touch screen or any combination thereof.

The processor 150 may be electrically connected to the communication device no, the memory 120, the interface device 130, the set speed control panel 140, and the like, may electrically control each component, and may be an electrical circuit that executes software commands, thereby performing various data processing and calculations described below.

The processor 150 may process a signal transferred between components of the autonomous driving control apparatus 100, and may perform overall control such that each of the components can perform its function normally. The processor 150 may be implemented in the form of hardware, software, or a combination of hardware and software, or may be implemented as microprocessor, and it may be, e.g., an electronic control unit (ECU), a micro controller unit (MCU), or other subcontrollers mounted in the vehicle.

The processor 150 may determine a speed limit of a driving road based on map information such as a navigation or road map information database (not illustrated), traffic information, or sign recognition information recognized by the sensing device 200.

The processor 150 may control an increase or decrease in a set speed depending on manipulation duration of the set speed control panel 140, and may control the vehicle to follow the set speed.

The processor 150 may determine increasing or decreasing manipulation depending on a manipulation direction of the set speed control panel 140. For example, the processor 150 may determine it is increasing when the manipulation direction of the set speed control panel 140 is upward and it is decreasing when the manipulation direction of the set speed control panel 140 is downward.

The processor 150 may determine whether the manipulation duration of the set speed control panel 140 is equal to or greater than a predetermined first reference value during the increasing manipulation of the set speed control panel 140.

The processor 150 may increase the set speed by a predetermined first unit when the manipulation duration of the set speed control panel 140 is smaller than the first reference value.

When the manipulation duration of the set speed control panel 140 is equal to or greater than the first reference value, the processor 150 may determine whether the manipulation duration of the set speed control panel 140 is equal to or greater than a second reference value that is greater than the first reference value. The processor 150 may increase the setting speed by a second unit that is greater than the first unit when the manipulation duration of the set speed control panel 140 is smaller than the second reference value. When the manipulation duration of the set speed control panel 140 is equal to or greater than the second reference value, the processor 150 may determine whether a currently set speed of the vehicle is smaller than a speed limit of a driving road. Then, when the current set speed of the vehicle is smaller than the speed limit of the driving road, the processor 150 may change the current set speed to the speed limit of the driving road.

In the meantime, when decreasing manipulation of the set speed control panel 140 is performed, the processor 150 may determine whether the manipulation duration of the set speed control panel 140 is equal to or greater than the predetermined first reference value, and when the manipulation duration of the set speed control panel 140 is smaller than the first reference value, may decrease the set speed by a first predetermined unit. In addition, when the manipulation duration of the set speed control panel 140 is greater than or equal to the predetermined first reference value, the processor 150 determines whether the manipulation duration of the set speed control panel 140 is greater than or equal to the second reference value that is greater than the first reference value, and when the manipulation duration of the set speed control panel 140 is smaller than the second reference value, may decrease the set speed by a second unit that is greater than the first unit. In addition, when the manipulation duration of the set speed control panel 140 is greater than or equal to the second reference value, the processor 150 may determine whether the current set speed exceeds the speed limit of the driving road, and when the current set speed exceeds the speed limit of the driving road, may change the current set speed to the speed limit of the driving road.

When the set speed control panel includes a button having a one-step pressing function, the processor 150 may determine a time for pressing and maintaining the button as manipulation duration.

In addition, the processor 150 may determine a time for pressing and maintaining a button having a two-step pressing function in one step (weak and shallow) or in two steps (strong and deep) as the manipulation duration. In this case, the set speed control panel 140 may include both a mechanical physical button and an electronic touch (electrostatic, decompressive) button.

When the set speed control panel 140 is the electronic touch (electrostatic, decompressive) button, the processor 150 may determine a time for swiping the corresponding button up or down (without releasing a hand after the swiping) as the manipulation duration.

When the set speed control panel 140 is the electronic touch (electrostatic, decompressive) button and a touch area of the set speed control panel 140 includes an increasing manipulation area for increasing the set speed and a decreasing manipulation area for decreasing the set speed, the processor 150 may determine a time for touching and maintaining each of the increasing manipulation area or the decreasing manipulation area as the manipulation duration.

When the set speed control panel 140 is a tumbler switch and lever switch, the processor 150 may determine a time for raising or lowering and maintaining the tumbler switch and the lever switch as the manipulation duration.

When the set speed control panel 140 is a lever switch, the processor 150 may determine a time for rotating and maintaining a rotation portion of the lever switch up or down as the manipulation duration.

For example, in the case where the current set speed of the autonomous vehicle is 30 and the speed limit of the driving road is 100, when the set speed control panel 140 is manipulated in an increasing direction, the set speed may be changed as illustrated in Table 1 depending on the manipulation duration (e.g., raising duration of the switch) of the set speed control panel 140.

TABLE 1

| | Manipulation duration of set | |
|---|---|---|
| Case | speed control panel | Changing set speed |
| \textcircled{1} | T < T1: Short key manipulation | Changing set speed by +1 |
| | with short raising duration of | to 31 |
| | switch | |
| \textcircled{2} | T1 ≤ T < T2: Short key | Changing set speed by +10 |
| | manipulation with long raising | to 40 |
| | duration of switch | |
| \textcircled{3} | T ≥ T2: Continuously maintaining | Changing set speed by +10 to |
| | long key input with long raising | 40 depending on satisfaction |
| | duration of switch | of CASE \textcircled{2} condition |
| | | Quickly changing set speed |
| | | from 40 to 100 depending on |
| | | satisfaction of CASE \textcircled{3} |
| | | condition |

In this case, T indicates the manipulation duration of the set speed control panel 140, and the first reference value T1 and the second reference value T2 may be variably set depending on experimental values. In addition, a change amount (e.g., 1, 10, etc.) and a unit of the set speed depending on a case may be variably set depending on the experimental values.

The autonomous driving control apparatus 100 may display the set speed on the interface device 130 as illustrated in Table 2 below.

TABLE 2

Displaying set speed (unit omitted)

| Case | Existing | Change |
|---|---|---|
| T < T1 | 30 | 31 |
| T1 ≤ T < T2 | | 40 |
| T ≥ T2 | | 40 → 100 |

The sensing device 200 may detect a speed limit of a driving road by detecting a vehicle surrounding environment, e.g., sign recognition information. To this end, the sensing device 200 may include a camera or the like.

The vehicle control device 300 may control a steering angle, braking, engine driving, shifting, etc. of the vehicle by interworking with the autonomous driving control apparatus 100. To this end, the vehicle control device 300 may include a steering wheel, an actuator interlocked with the steering wheel, and a controller for controlling the actuator. In addition, the vehicle control device 300 may include a controller for controlling a brake. The vehicle control device 300 may include a controller for controlling a speed of the vehicle.

As such, according to embodiments of the present disclosure, it is possible to control the vehicle to follow a predetermined set speed during autonomous driving, and in this case, the set speed may be changed based on the manipulation duration of the set speed control panel 140 and a road speed limit. In particular, according to embodiments of the present disclosure, it is possible to set the set speed intuitively and always quickly while using an existing general set speed control system.

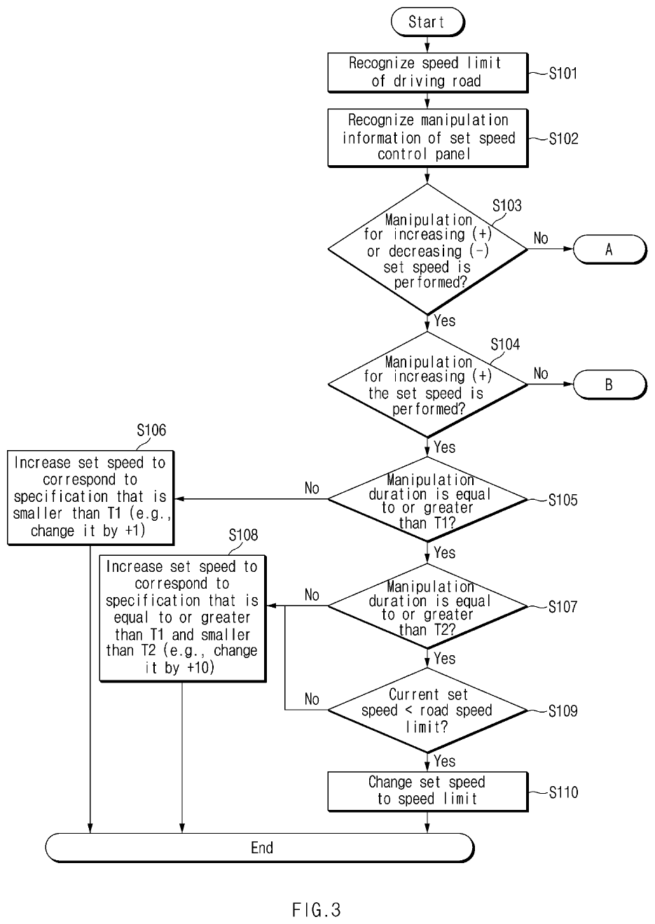

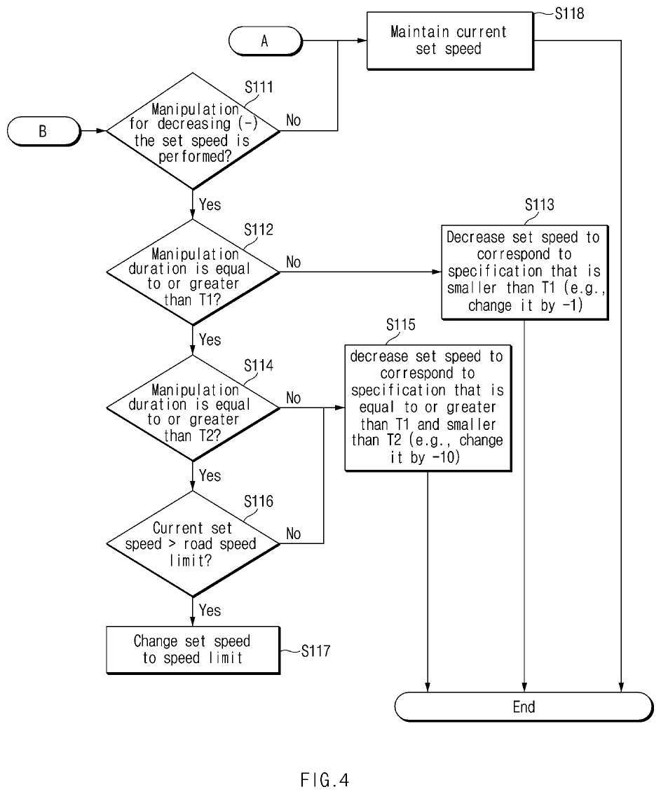

Hereinafter, a set speed control method according to an exemplary embodiment of the present disclosure will be described in detail with reference to FIG. 3 and FIG. 4. FIG. 3 and FIG. 4 each illustrate a flowchart showing a set speed control method during autonomous driving control according to exemplary embodiments of the present disclosure. Hereinafter, it is assumed that the autonomous driving control apparatus 100 of FIG. 1 performs the processes of FIG. 3 and FIG. 4. In addition, in the description of FIG. 3 and FIG. 4, operations described as being performed by the device may be understood as being controlled by the processor 150 of the autonomous driving control apparatus 100.

Referring to FIG. 3, the autonomous driving control apparatus 100 recognizes a speed limit of a driving road (S101). The autonomous driving control apparatus 100 may recognize a speed limit of a driving road based on a sensing result of the sensing device 200 or map information or traffic information of a navigation system (not illustrated).

The autonomous driving control apparatus 100 recognizes manipulation information (increase or decrease) of the set speed control panel 140 (S102). That is, the autonomous driving control apparatus 100 may recognize an increase in the set speed or a decrease in the set speed through a manipulation direction, manipulation duration, etc. of the set speed control panel 140.

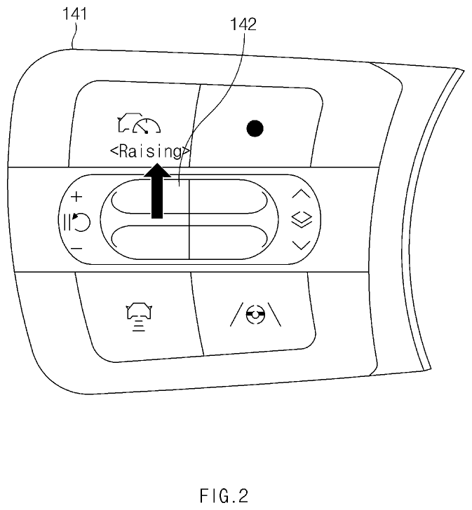

Next, the autonomous driving control apparatus 100 determines whether manipulation of the set speed control panel 140 for increasing or decreasing the set speed has been performed (S103). That is, when the roll 142 of the roll switch 141 of the set speed control panel 140 of FIG. 2 is manipulated in an upward direction, it may be determined that an increasing manipulation has been performed, and when the roll 142 of the roll switch 141 moves in a downward direction, it may be determined that a decreasing manipulation has been performed.

When the set speed control panel 140 for increasing or decreasing the set speed is made, the autonomous driving control apparatus 100 determines whether the manipulation is for increasing the set speed (S104).

When the manipulation is for increasing the set speed, the autonomous driving control apparatus 100 determines whether the manipulation duration of the set speed control panel 140 is equal to or greater than a predetermined first reference value T1 (S105). In this case, the first reference value T1 may be determined in advance as an experimental value.

When the manipulation duration of the set speed control panel 140 is not equal to or greater than (is smaller than) the predetermined first reference value T1, the autonomous driving control apparatus 100 may set the set speed to a specification corresponding to a manipulation that is smaller than the first reference value T1, for example, may increase the set speed by a predetermined unit (e.g., 1 unit) (S106).

On the other hand, when the manipulation duration of the set speed control panel 140 is equal to or greater than the predetermined first reference value T1, the autonomous driving control apparatus 100 determines whether the manipulation duration of the set speed control panel 140 is equal to or greater than a predetermined second reference value T2 (S107). In this case, the second reference value is greater than the first reference value, and the second reference value may be determined in advance by an experimental value.

On the other hand, when the manipulation duration of the set speed control panel 140 is not greater than or equal to (is smaller than) the second reference value T2, the autonomous driving control apparatus 100 may set the set speed to a specification corresponding to a manipulation in which the manipulation duration of the set speed control panel 140 is greater than or equal to the predetermined first reference value and smaller than the second reference value (S108). For example, the set speed may be increased by a predetermined unit (e.g., 10 units).

On the other hand, when the manipulation duration of the set speed control panel 140 is equal to or greater than the predetermined second reference value T2, the autonomous driving control apparatus 100 determines whether the current set speed is lower than the speed limit of the driving road (S109).

When the current set speed is not lower than (is equal to or higher than) the speed limit of the driving road, the autonomous driving control apparatus 100 performs the above step S108, and when the current set speed is lower than the speed limit of the driving road, changes the set speed to the speed limit of the driving road (Silo).

On the other hand, when the manipulation of the set speed control panel 140 for increasing or decreasing the set speed is not performed in the step S103, it may proceed to A of FIG. 4.

Referring to FIG. 4, when the manipulation of the set speed control panel 140 for increasing or decreasing the set speed is not performed, the autonomous driving control apparatus 100 may maintain the current set speed (S118).

On the other hand, when the manipulation of the set speed control panel 140 is not for increasing the set speed, i.e., is for decreasing the set speed, it may proceed to B of FIG. 4.

Referring to FIG. 4, when the manipulation of the set speed control panel 140 is not for increasing the set speed, the autonomous driving control apparatus 100 determines whether the manipulation is for decreasing the set speed (Sin), and when the manipulation is not for decreasing the set speed, it maintains the current set speed as in step S118 above.

On the other hand, when the manipulation is for decreasing the set speed, the autonomous driving control apparatus 100 determines whether the manipulation duration of the set speed control panel 140 is equal to or greater than a predetermined first reference value T1 (S112).

When the manipulation duration of the set speed control panel 140 is not equal to or greater than (is smaller than) the predetermined first reference value T1, the autonomous driving control apparatus 100 may set the set speed to a specification corresponding to manipulation that is smaller than the first reference value, for example, may decrease the set speed by a predetermined unit (e.g., 1 unit) (S113).

On the other hand, when the manipulation duration of the set speed control panel 140 is equal to or greater than the predetermined first reference value T1, the autonomous driving control apparatus 100 determines whether the manipulation duration of the set speed control panel 140 is equal to or greater than the predetermined second reference value T2 (S114).

When the manipulation duration of the set speed control panel 140 is not greater than or equal to (is smaller than) the second reference value T2, the autonomous driving control apparatus 100 may set the set speed to a specification corresponding to a manipulation in which the manipulation duration of the set speed control panel 140 is greater than or equal to the predetermined first reference value and smaller than the second reference value (S115). For example, the set speed may be decreased by a predetermined unit (e.g., 10 units).

On the other hand, when the manipulation duration of the set speed control panel 140 is equal to or greater than the predetermined second reference value T2, the autonomous driving control apparatus 100 determines whether the current set speed exceeds the speed limit of the driving road (S116).

When the current set speed does not exceed (is equal to or lower than) the speed limit of the driving road, the autonomous driving control apparatus 100 performs the above step S115, and when the current set speed exceeds the speed limit of the driving road, changes the set speed to the speed limit of the driving road (S117).

As such, according to embodiments of the present disclosure, when changing the set speed of the autonomous driving system, manipulation may be recognized in a significantly shorter time compared to conventional manipulation methods by setting or changing the set speed by determining an increasing or decreasing amount of the set speed based on manipulation duration of the set speed control panel, thereby increasing commercialization of the autonomous driving system by enabling the set speed to be changed immediately.

In addition, according to embodiments of the present disclosure, it is possible to reduce a cost and simplify a function by using the manipulation duration without adding a separate manipulation system switch.

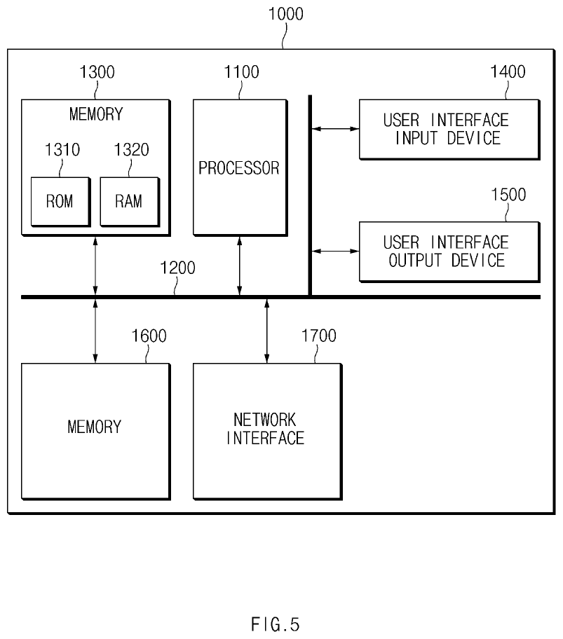

FIG. 5 illustrates a computing system according to an exemplary embodiment of the present disclosure.

Referring to FIG. 5, the computing system 1000 includes at least one processor 1100 connected through a bus 1200, a memory 1300, a user interface input device 1400, a user interface output device 1500, and a memory (i.e., a storage) 1600, and a network interface 1700.

The processor 1100 may be a central processing unit (CPU) or a semiconductor device that performs processing on commands stored in the memory 1300 and/or the memory 1600. The memory 1300 and the memory 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the memory 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous driving control apparatus comprising:
a set speed control panel configured to be manipulated to adjust a set speed that is followed by a vehicle during autonomous driving; and
a processor configured to control an increase or a decrease in the set speed to set an adjusted set speed based on a manipulation duration of the set speed control panel and to control the vehicle to follow the adjusted set speed.

2. The autonomous driving control apparatus of claim 1, wherein the processor is configured to determine whether a manipulation is an increasing manipulation or a decreasing manipulation based on a manipulation direction of the set speed control panel.

3. The autonomous driving control apparatus of claim 2, wherein, in response to a determination that the manipulation is the increasing manipulation, the processor is configured to determine whether the manipulation duration of the set speed control panel is equal to or greater than a predetermined first reference value.

4. The autonomous driving control apparatus of claim 3, wherein, in response to a determination that the manipulation duration of the set speed control panel is not equal to or greater than the predetermined first reference value, the processor is configured to increase the set speed by a first predetermined unit.

5. The autonomous driving control apparatus of claim 4, wherein, in response to a determination that the manipulation duration of the set speed control panel is equal to or greater than the predetermined first reference value, the processor is configured to determine whether the manipulation duration of the set speed control panel is equal to or greater than a second reference value that is greater than the predetermined first reference value.

6. The autonomous driving control apparatus of claim 5, wherein, in response to a determination that the manipulation duration of the set speed control panel is not equal to or greater than the second reference value, the processor is configured to increase the set speed by a second unit that is greater than the first predetermined unit.

7. The autonomous driving control apparatus of claim 5, wherein:
in response to a determination that the manipulation duration of the set speed control panel is equal to or greater than the second reference value, the processor is configured to determine whether a current set speed of the vehicle is lower than a speed limit of a driving road; and
in response to a determination that the current set speed is lower than the speed limit of the driving road, the processor is configured to change the current set speed of the vehicle to the speed limit of the driving road.

8. The autonomous driving control apparatus of claim 2, wherein, in response to a determination that the manipulation is the decreasing manipulation, the processor is configured to determine whether the manipulation duration of the set speed control panel is equal to or greater than a predetermined first reference value.

9. The autonomous driving control apparatus of claim 8, wherein, in response to a determination that the manipulation duration of the set speed control panel is not equal to or greater than the predetermined first reference value, the processor is configured to decrease the set speed by a first predetermined unit.

10. The autonomous driving control apparatus of claim 9, wherein, in response to a determination that the manipulation duration of the set speed control panel is equal to or greater than the predetermined first reference value, the processor is configured to determine whether the manipulation duration of the set speed control panel is equal to or greater than a second reference value that is greater than the predetermined first reference value.

11. The autonomous driving control apparatus of claim 10, wherein, in response to a determination that the manipulation duration of the set speed control panel is not equal to or greater than the second reference value, the processor is configured to decrease the set speed by a second unit that is greater than the first predetermined unit.

12. The autonomous driving control apparatus of claim 11, wherein:
in response to a determination that the manipulation duration of the set speed control panel is equal to or greater than the second reference value, the processor is configured to determine whether a current set speed of the vehicle exceeds a speed limit of a driving road; and
in response to a determination that the current set speed exceeds the speed limit of the driving road, the processor is configured to change the current set speed to the speed limit of the driving road.

13. An autonomous driving control apparatus comprising:
a set speed control panel configured to be manipulated to adjust a set speed that is followed by a vehicle during autonomous driving, wherein the set speed control panel comprises a ball-type scroll switch, a roll-type scroll switch, a lever switch, a left-right rotation scroll switch, a touch screen, a button, a tumbler switch, or any combination thereof; and
a processor configured to control an increase or a decrease in the set speed to set an adjusted set speed based on a manipulation duration of the set speed control panel and to control the vehicle to follow the adjusted set speed.

14. The autonomous driving control apparatus of claim 13, wherein the set speed control panel comprises the button, the button includes a one-step pressing function, and the processor is configured to determine a time for pressing and maintaining the button as the manipulation duration.

15. The autonomous driving control apparatus of claim 13, wherein the set speed control panel comprises the button, the button includes a two-step pressing function, and the processor is configured to determine a time for pressing and maintaining the button as the manipulation duration based on a pressing strength of the button.

16. The autonomous driving control apparatus of claim 13, wherein the set speed control panel comprises the button, the button is a touch button, and the processor is configured to determine a time for swiping and maintaining the touch button up or down as the manipulation duration.

17. The autonomous driving control apparatus of claim 13, wherein the set speed control panel comprises the button, the button is a touch button comprising an increasing manipulation area to increase the set speed and a decreasing manipulation area to decrease the set speed, and the processor is configured to determine a time for touching and maintaining the increasing manipulation area or the decreasing manipulation area as the manipulation duration.

18. The autonomous driving control apparatus of claim 13, wherein the set speed control panel comprises the tumbler switch or the lever switch, and wherein the processor is configured to determine a time for raising and maintaining or lowering and maintaining the tumbler switch or the lever switch as the manipulation duration.

19. The autonomous driving control apparatus of claim 13, wherein the set speed control panel comprises the lever switch, and wherein the processor is configured to determine a time for rotating and maintaining a rotation portion of the lever switch up or down as the manipulation duration.

20. An autonomous driving control method for a vehicle, the method comprising:
receiving manipulation of a set speed control panel to adjust a set speed for the vehicle to follow during autonomous driving;
controlling an increase or a decrease in the set speed to set an adjusted set speed based on a manipulation duration of the manipulation of the set speed control panel; and
controlling the vehicle to follow the adjusted set speed.
